(19) United States
(12) Patent Application Publication
(10) Pub. No.: US 2006/0227007 A1
(43) Pub. Date: Oct. 12, 2006

(54) Sensor unit, and housing-relay for the production of said unit

(76) Inventor: Franck Landrieve, Fondettes (FR)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 10/548,866

(22) PCT Filed: Mar. 16, 2004
(86) PCT No.: PCT/FR04/00639

§ 371 Date: Mar. 14, 2006

(30) Foreign Application Priority Data
Mar. 27, 2003 (FR) 03/03780

(51) Int. Cl. G08C 19/00; G08C 19/38

(52) U.S. Cl. 340/870.3

(57) ABSTRACT

A sensor unit, and a housing-relay for the production of said unit. A sensor unit for roller skates, skateboards or cycles, comprising a detector consisting of at least one sensor and a primary emitter, said emitter being able to emit a primary signal from a measurement signal provided by the sensor; a remote housing-relay which can be worn by a user, comprising a primary receptor which can receive the primary signal and a secondary emitter which can emit a secondary signal; in addition to a remote display which can be worn by a user, comprising a secondary receiver which can receive the secondary signal and a display device.

### BACKGROUND OF THE INVENTION

1. Field of the Invention

The present invention relates to a sensor unit, particularly for roller skates, skateboards or cycles, that is used to provide indications to this user, and a housing-relay for the production of said unit.

2. Description of the Relevant Art

Provision can be made to furnish roller skates or skateboards with sensors placed on the wheels to measure wheel rotation parameters in order to provide a user for example with an indication of speed or distance.

A sensor may be associated with a transmitter, the sensor and the transmitter being placed in the wheel or in an attachment element of the wheel. The transmitter transmits wireless measurement signals, particularly via radio waves, to a remote display device, for example provided in the form of a wristband furnished with a display screen. Reference may be made for example to document EP 354 359 B1.

Such sensor-transmitter devices are housed in small wheels, so this requires reduced dimensions for the transmitter, particularly for a radio transmission antenna or for a power supply device. This limits the emission power that may be obtained.

In addition, the transmitter is surrounded by solid masses, and particularly by metal masses such as a wheel attachment platform that is capable of forming a screen to the transmission of radio waves. The transmitter is also masked from a receiver of the remote display device by the roller skate shoe or the skateboard and the body of the skater. This results in interference in the transmission of the signals and difficulties in receiving the signals at the display device.

### SUMMARY OF THE INVENTION

One object of the present invention is to remedy the aforementioned disadvantages by proposing a sensor unit for roller skates, skateboards or cycles, that can be worn by a user, in particular while practicing a sport, and that allows an improved transmission of measurement signals from a sensor placed on a roller skate, a skateboard or a cycle to a remote readout element worn by the user.

The invention also proposes a sensor unit that reduces the sensitivity of the sensor unit to outside interference.

The invention also proposes a multipurpose sensor unit whose functionalities may be increased to allow different uses.

The invention also proposes a sensor unit that is simple and can be easily fitted to a roller skate or a skateboard.

A sensor unit for roller skates, skateboards or cycles, comprises a detector comprising at least one sensor capable of providing a measurement signal representative of at least one wheel rotation parameter, and a primary transmitter, said primary transmitter being capable of transmitting a primary signal based on a measurement signal provided by the sensor. The unit comprises a remote housing-relay intended to be placed on a limb of a user, a shoe, a roller skate, a skateboard or a cycle frame, said housing comprising a primary receiver capable of receiving the primary signal and a secondary transmitter capable of transmitting a secondary signal corresponding to the primary signal, and a remote readout element intended to be worn by a user, said readout element comprising a secondary receiver capable of receiving the secondary signal and a display device.

The housing-relay may be worn by the user by placing it on a limb of a user or on a shoe, on a roller skate, a skateboard or a cycle frame. The housing-relay is preferably placed close to the wheel furnished with the detector.

Thanks to the housing-relay, a primary transmitter suitable for transmitting the signals over a short distance can be provided, for example, by radio waves, at a low power. The housing-relay is used for receiving the primary signals and retransmitting them at a greater power, to the remote display.

In one embodiment, the detector is attached to an axle used for the rotational mounting of a wheel and for the attachment of the latter. This produces a compact sensor unit. In addition, a wheel may be easily fitted with a sensor unit by modifying the wheel attachment axle. Preferably, a transmitter of the detector is mounted nonrotatably.

In one embodiment, the primary transmitter comprises a processing stage capable of providing a primary signal encoding the measurement signal and a primary identification code, the housing-relay comprising a processor unit capable of identifying the primary signal according to said primary identification code. The addition to the measurement signal of a primary identification code prevents interference, the housing-relay processing only the signals transmitted by the associated primary transmitter.

In one embodiment, the housing-relay comprises a processor unit capable of providing a secondary signal encoding a measurement signal and a secondary identification code, the secondary receiver comprising a processing stage capable of identifying the secondary signal according to said secondary identification code. The provision of a secondary identification code allows the secondary receiver to select and process only the secondary signals originating from the associated housing-relay, to prevent interference by signals transmitted by the associated primary transmitter to the housing-relay and to the readout element, and by external signals.

In one embodiment, the housing-relay comprises an accelerometer and a processor unit capable of processing a measurement signal from the accelerometer and of causing the emission of a corresponding secondary signal to the readout element. The housing-relay furnished with an accelerometer may thus be used as a pedometer by being attached to a limb or a walking shoe of a user.

In one embodiment, the housing-relay comprises selection means for the emission of secondary signals according to an accelerometer or according to a primary signal.

In one embodiment, the housing-relay is furnished with removable attachment elements for example on a shoe or on a lower limb of a person. The readout element may be furnished with attachment means to be carried directly by the user or on an item of the user's equipment, such as a cycle frame.

The invention also relates to a housing-relay for the production of a unit comprising a primary receiver capable of receiving primary signals encoding a measurement signal and a primary identification code, a processor unit capable of extracting the measurement signal from the primary signal and of forming a secondary signal encoding the measurement signal and a secondary identification code, and a secondary transmitter for the transmission of said secondary signal.

### BRIEF DESCRIPTION OF THE DRAWINGS

Other objects, features and advantages of the invention will appear on reading the following description, given as a non-limiting example, and made with reference to the appended drawings in which:

FIG. 1 is a general schematic view of a skater using a sensor unit according to one aspect of the invention;

FIG. 2 is a schematic view of a roller skate shoe furnished with a detector and a housing-relay for the production of a sensor unit according to one aspect of the invention;

FIG. 3 is a top view of a housing-relay according to one aspect of the invention; and

FIG. 4 is a functional block diagram of the sensor-unit according to one aspect of the invention.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

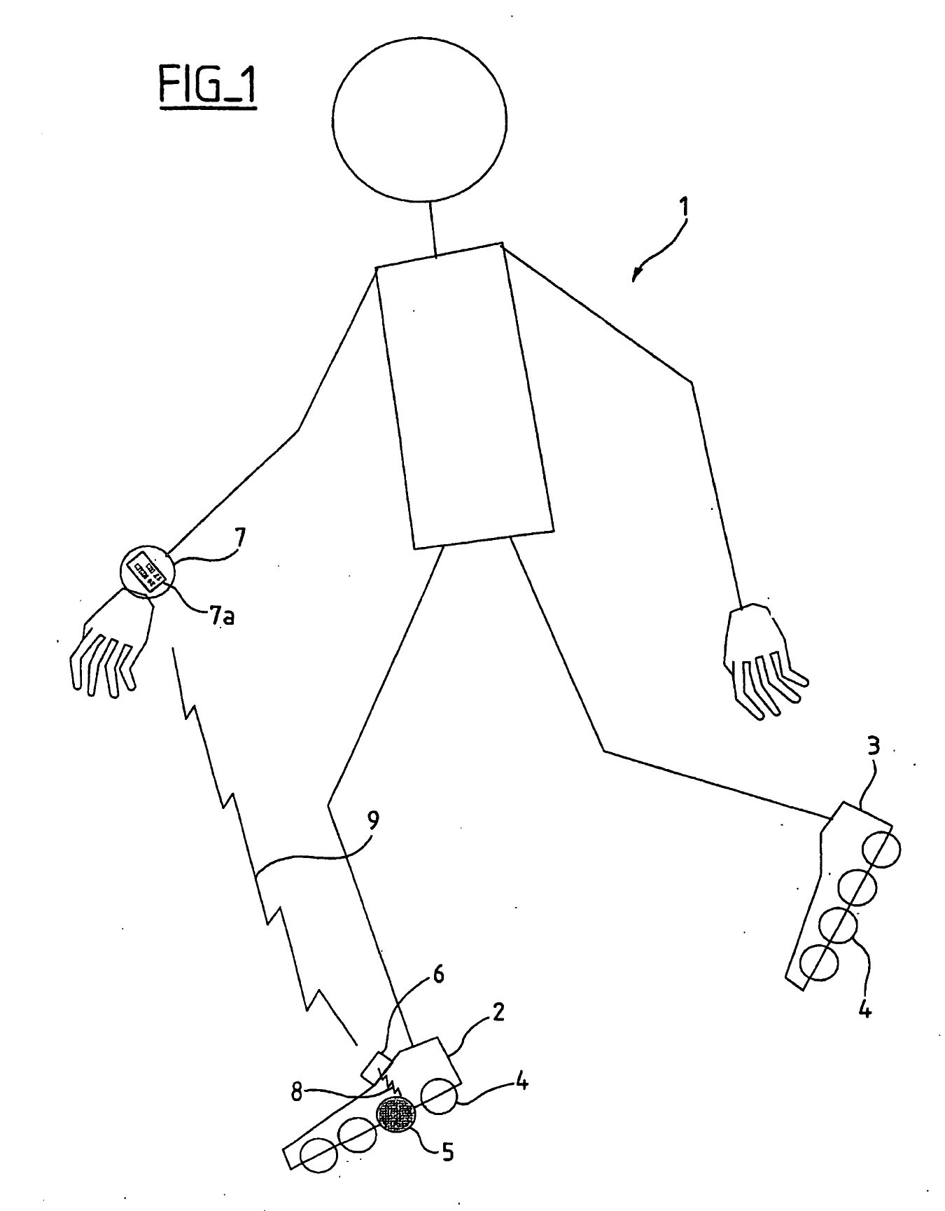

In FIG. 1, a skater 1 is shod with roller skates 2, 3 furnished with wheels 4 placed in line.

A skate 2 comprises an instrumented wheel 5, shaded in FIG. 1, furnished with a detector (not shown) comprising a sensor capable of providing a measurement signal representative of at least one rotation parameter of the instrumented wheel 5, and a primary transmitter for the emission of primary radiofrequency signals corresponding to the measurements. A housing-relay 6, which will be better described hereinafter, is attached to the top of the skate shoe 2. The skater 1 wears on his wrist a readout element 7 furnished with a wristband (not visible) and an information display screen 7a.

As schematized by the jagged lines 8, 9, the housing-relay 6 may receive primary radiofrequency signals transmitted by the primary transmitter of the detector of the instrumented wheel 5, and the readout element 7 may receive secondary radio signals transmitted by the housing-relay 6.

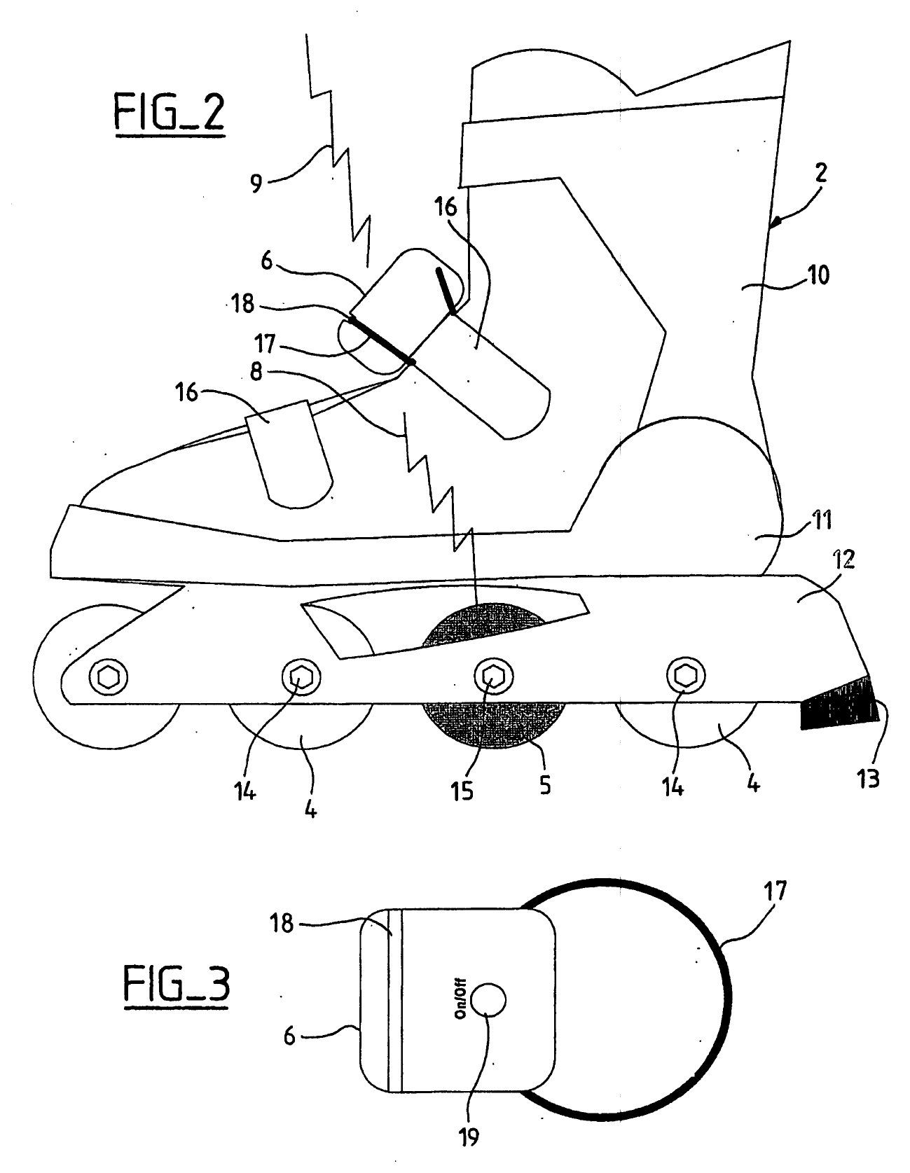

In FIG. 2, in which the numbers referring to elements similar to those in FIG. 1 have been used again, the skate 2 comprises a boot or shoe 10 beneath whose sole 11 is attached a platform 12 furnished at its rear end with a brake 13 and supporting wheels 4, here four in number, disposed in line and each attached to the platform 12 by means of an axle 14.

An instrumented wheel 5, shaded in FIG. 2, is furnished with a detector (not shown) provided in the form of a sensor and with a primary transmitter and is supported by an axle 15 for attachment of the instrumented wheel 5 rotatable on the platform 12. For further details concerning the structure and assembly of the axle 15 and of the instrumented wheel 5, and the disposition of the detector, reference may be made to document FR 2 820 476.

The shoe 10 is furnished with fastening and tightening means in the form of tongues 16. A housing-relay 6 is placed on the top of the shoe 10, at the kick level, while being attached to one of the tongues 16. For its attachment, the housing-relay 6 comprises an elastic ring 17 which is passed under the tongue 16 while being stretched and passed into a groove 18 provided on the face of the housing 6 oriented on the side opposite to the shoe 10. Thus, the elastic ring 17 holds the housing 6 on the shoe 10. The groove 18 is used to hold the elastic ring 17 in position. The groove 18 has, in cross section, a profile suited to holding the elastic ring 17 tight and wound around an element on the side of the housing 6 opposite to the groove, the end of the elastic ring 17 being brought back and placed in the groove 18.

In FIG. 3, in which the numbers referring to the elements similar to those in the preceding figures have been used again, the housing 6 is shown unattached.

The housing-relay 6 is furnished on its upper face with the groove 18 and with an on/off button 19. The housing 6 also comprises the elastic ring 17 attached to the housing 6 at a distance from the groove 18.

The housing-relay 6 is powered in a known manner, with the aid of a battery or an accumulator.

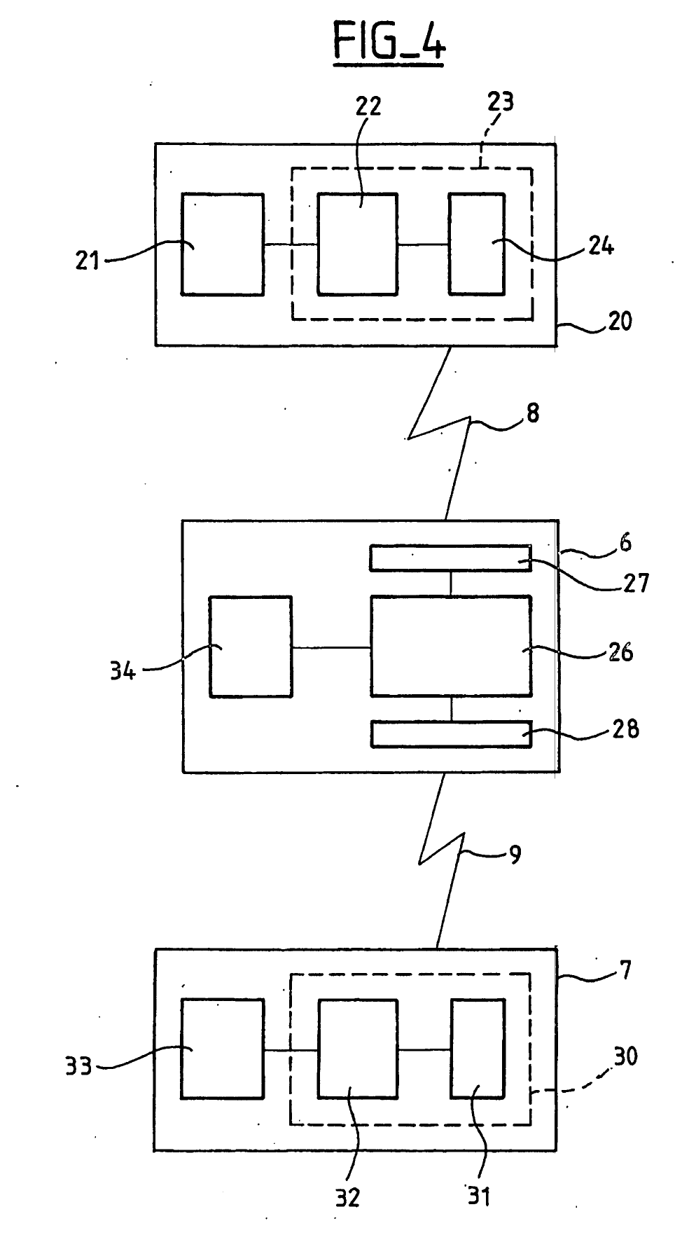

In FIG. 4, where the numbers referring to elements similar to those in the preceding Figures have been used again, a sensor unit comprises a detector 20, is designed to be housed in a wheel or mounted on an attachment element of a wheel, for example on a rotational axle of a wheel, a housing-relay 6, and a readout element 7, which are at a distance from one another.

The detector 20 comprises a sensor 21 attached to a processing stage 22 of a radioelectric primary transmitter 23, itself connected to a radio antenna 24 of the primary transmitter 23.

The housing-relay 6 comprises a processor unit 26 connected to a primary radioelectric receiver 27 in the form of a receiving antenna, and to a secondary radioelectric transmitter 28 in the form of a transmitting antenna. The processor unit 26 comprises a microprocessor (not shown) and memory means (not shown) in which at least one program is stored that can be used by the microprocessor.

The readout element 7 comprises a secondary radioelectric receiver 30 comprising a secondary receiving antenna 31 connected to a secondary processing stage 32 of the secondary receiver 30, itself connected to a display device 33, which may be for example a liquid crystal display screen.

In operation, the sensor 21 transmits an analog measurement signal that is transmitted to the primary processing stage 22 which provides, periodically or continuously, a digital primary signal encoding the measurement signal and a primary identification code. Since the processing stage 22 forms a radio circuit for the antenna 24, the primary signal attacks the primary antenna 24 which transmits a radio wave represented schematically by a jagged line 8.

The radio wave 8 is received by the primary receiver 27 of the housing-relay 6 and transmitted to the processor unit 26 which can identify said primary signal as originating from the detector 20 associated with the housing-relay 26 thanks to the primary identification code of the primary signal. If the primary identification code is validated, the processor unit 26 extracts the frame encoding the measurement signal from the primary signal, and forms a secondary digital signal encoding the measurement signal and a secondary identification code.

The processor unit 26 forming a radio circuit for the secondary transmitter 28 causes the emission of a radiofrequency wave represented schematically by a jagged line 9. The secondary receiving antenna 31 of the readout element 7 receives the radiofrequency wave 9. The secondary processing stage 32 identifies the signal with the aid of the secondary identification code. If the signal is validated as originating from the intermediate housing 25 associated with the readout element 29, the processing stage 32 extracts the measurement signal and transmits to the display device 33 a signal for displaying data corresponding to the initial measurement signal provided by the sensor 21.

As shown in FIG. 4, the housing-relay 6 may optionally comprise an accelerometer 34 connected to the processor unit 26. The accelerometer 34, associated with an appropriate processing software program stored in the memory means of the processor unit 26 and capable of being used by the microprocessor of the unit 26, is thus used to obtain a pedometer.

Advantageously, the housing 6 may be furnished with a selector button, not shown, for an operation in pedometer mode or in housing-relay mode.

When the housing-relay 6 is operating as a pedometer, it may advantageously be attached to a lower limb of the person or to a walking shoe. The accelerometer 34 transmits measurement signals to the processor unit 26 which causes the emission of a secondary signal encoding the accelerometer measurement signal and a secondary identification code, the secondary signal being transmitted by the secondary transmitter 28 to the readout element 7. The user furnished with the readout element 7 may thus determine a number of steps taken.

Operations for processing measurement signals for the purpose of converting them into appropriate magnitudes for the user (distance traveled, instantaneous speed, average speed), may be carried out by the processing stage of the detector 20, and preferably by the processor unit 26 of the housing 6 or the processor stage 32 of the readout element 7 which may be used independently of the detector, during use as a pedometer.

The use of primary and secondary identification codes prevents any interference with the radiofrequency transmissions by a similar system used nearby. Specifically, a radiofrequency signal received by the primary receiver 27 or the secondary receiver 30 and not comprising an appropriate identification code will not be processed. Furthermore, the use of different primary and secondary identification codes prevents interference between the secondary and primary radiofrequency emissions.

As can be better seen in FIGS. 1 and 2, the housing-relay is close to the instrumented wheel. Consequently, a primary transmitter suitable for the transmission of radiofrequency waves over short distances may be provided. The power necessary for the primary transmitter to transmit radiofrequency waves is then low. The risk that elements might be interposed between the primary transmitter and the primary receiver of the housing 6 is low.

On the other hand, the distance between the housing-relay and the readout element is greater. Nevertheless, the antenna of the secondary transmitter of the housing-relay may be provided with greater dimensions than the antenna of the primary transmitter because the space available is not limited. In addition, the antenna of the secondary transmitter is stripped of any metal part that may harm the transmission of radiofrequency waves. The reception by the readout element is thus improved.

Thanks to the invention, a sensor unit is obtained that can be used for the transmission of measurement signals by a sensor situated on a wheel to a remote readout element without the risk of interference in the transmission of the signals, and while simplifying and optimizing the design of a sensor-transmitter device placed on a wheel. The sensor unit may also be easily adapted for additional uses, such as a use as a pedometer.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A sensor unit for roller skates, skateboards or cycles, comprising a detector comprising at least one sensor capable of providing a measurement signal representative of at least one wheel rotation parameter, and a primary transmitter said primary transmitter being capable of transmitting a primary signal based on a measurement signal provided by the sensor, the sensor unit further comprising a remote housing-relay intended to be placed on a limb of a user, a shoe, a roller skate, a skateboard or a cycle frame, said housing comprising a primary receiver capable of receiving the primary signal and a secondary transmitter capable of transmitting a secondary signal corresponding to the primary signal, and a remote readout element intended to be worn by a user, said readout element comprising a secondary receiver capable of receiving the secondary signal and a display device.

2. The unit as claimed in claim 1, wherein the detector is attached in a wheel.

3. The unit as claimed in claim 1, wherein the detector is attached to an axle used for the rotational mounting of a wheel.

4. The unit as claimed in claim 3, wherein a transmitter of the detector is mounted nonrotatably on the axle.

5. The unit as claimed in claim 1, wherein the primary transmitters comprises a processing stage capable of providing a primary signal encoding the measurement signal and a primary identification code, the housing relay comprising a processor unit capable of identifying the primary signal according to said primary identification code.

6. The unit as claimed in claim 1, wherein the housing-relay comprises a processor unit capable of providing a secondary signal encoding a measurement signal and a secondary identification code, the secondary receiver comprising a processing stage capable of identifying the secondary signal according to said secondary identification code.

7. The unit as claimed in claim 1 wherein the housing-relay comprises an accelerometer and a processor unit capable of processing a measurement signal of the accelerometer and of causing the transmission of a corresponding secondary signal to the readout element.

8. The unit as claimed in claim 7, wherein the housing-relay comprises selection means for the transmission of secondary signals according to an accelerometer or according to a primary signal.

9. The unit as claimed claim 1, wherein the housing-relay is furnished with removable attachment elements.

10. The unit as claimed in claim 1, wherein the readout element is furnished with means of direct attachment to the user and/or an item of the user's equipment, such as a cycle frame.

11. A housing-relay for the production of a unit as claimed in claim 1, comprising a primary receiver capable of receiving primary signals encoding a measurement signal and a primary identification code, a processor unit capable of extracting the measurement signal from the primary signal and of forming a secondary signal encoding the measurement signal and a secondary identification code, and a secondary transmitter for the transmission of said secondary signal.
